(19) United States
(12) Patent Application Publication
(10) Pub. No.: US 2008/0256058 A1
(43) Pub. Date: Oct. 16, 2008

(54) Highlighting of Search Terms in a Meta Search Engine

(76) Inventor: Mikael Kother, Rhode-Saint-Genese (BE)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/817,781

(22) PCT Filed: Mar. 11, 2005
(86) PCT No.: PCT/EP05/51102

§ 371 Date: Apr. 29, 2008

(51) Int. Cl. G06F 17/30

(52) U.S. Cl. 707/5; 707/E17.001

(57) ABSTRACT

The invention relates to a method performed by a computer program for presenting data from a collection of documents, including retrieving (6) a search string; identifying (7) items within the string; making (8) a query to search engines; retrieving (10) from the engines document references; and retrieving (12) documents referenced in the retrieved set. The method further includes generating a user interface (28) including a pane (24) showing (16) a view of a referenced document, a first occurrence of the items being visible; and including interacting means for interacting in a single operation to trigger if the first document contains a further occurrence of the items, the showing (22) in the pane (24) of another view of the first document, with the further occurrence being visible; and otherwise, the showing (23) in the pane (24) of a view of another document, an occurrence of the items being visible.

### FIELD OF THE INVENTION

The invention relates to a method performed by a computer program within a computer for presenting data from a collection of documents, including the steps of retrieving a search character string; identifying at least one item within the string; making a query depending on the string to at least one search engine capable of returning a set of references to documents from the collection; retrieving from the engine a set of at least one document reference; and retrieving at least one document referenced in the retrieved set.

The invention also relates to a computer program comprising program instructions for causing a computer to perform the above-mentioned method, to a computer containing said computer program, and to a carrier having thereon said computer program.

The invention further relates to a computer containing a computer program for generating a user interface for use in the above-mentioned method, and to an information processing apparatus for presenting data from a collection of documents.

### DESCRIPTION OF PRIOR ART

Such methods, computer programs, computers, carriers, computers containing a computer program for generating a user interface, and information processing apparatuses are known in the art.

For instance, U.S. Pat. No. 5,913,215 discloses a method for identifying one of a plurality of documents stored in a computer-readable medium. The method includes prompting a computer user to construct a search expression, communicating the search expression to web search engines in order for them to identify pages containing text consistent with the search expression and to return a URL for each such web page identified.

Redundant URLs returned by the search engines are filtered to obtain a set of web pages. Each of the set of web pages is downloaded and linguistically analyzed to automatically identify for the user keyword phrases therein. The user is then prompted to construct a query expression in which one or more keyword phrases from the initial set of web pages is an operand. The query expression is then used to identify at least one web page of the set of web pages and the identified web page is presented to the user in the form of an abstract.

While this method of the prior art is attractive, it presents a certain number of drawbacks. First of all, when searching a collection of documents, a user may find annoying the need of refining the search before being presented with a document or web page and the need of clicking on a reference link in order to obtain a view of a document or web page. This method may lead to long and frustrating searches and it is recognised that there is a need for a faster and user-friendlier search method or method for presenting data from a collection of documents.

### SUMMARY OF THE INVENTION

It is an object of the invention to solve at least partially the problems of the prior art.

To this end, the method according to the invention is characterised by further including a step of generating a signal capable of graphically presenting in a display a user interface including a pane showing a view of a first one of the at least one referenced document, a first occurrence of the at least one item being visible; and including interacting means for a user to interact in a single operation through an input device to trigger, if the first document contains a further occurrence of the at least one item, the showing in the pane of another view of the first document, with the further occurrence being visible; and otherwise, the showing in the pane of a view of another one of the at least one referenced document, an occurrence of the at least one item being visible.

Within the method according to the invention, a computer program retrieves a search character string, for instance by prompting a user to enter a search character string and retrieving it or by retrieving a string directly from a text file, and it identifies at least one item within said string, for instance a plurality of words. Then the program queries the search engine or the plurality of search engines, for instance Google or the like, and after the search engines have each returned a list of search results, these results, i.e. the references to documents, are retrieved, and a first one of the documents pointed by these results is retrieved.

A user interface generated by the computer program then directly presents a view pane showing a view of the first referenced document with a first occurrence of an item being visible, so that the user is rapidly and transparently presented with a view of a relevant part of a relevant document. That is, the user is presented with a document which is consistent with the search character string or containing the string, and is further presented with a section of this document, the section containing an item included in the search string. The user neither needs to select a reference from a list nor select a particular section of a document to find relevant information.

In addition to and in combination with this view pane appearing in a quick and direct manner, the user interface generated by the computer program includes means operable for enabling the user to interact in a single operation through an input device and trigger the showing in the pane of either another view of the currently shown document or a view of another referenced document. In response to the single operation, another view of the current document is shown if the document contains at least one item which has not been shown yet, while a view of another document is shown once all items of the first document have been shown.

The user needs not make a conscious distinction between these two cases or events. As a result, the user can rapidly and transparently skim through the successive views by a succession of single operations leading him from one item to another, and the method according to the invention is user-friendlier and faster than prior art methods.

Documents may for instance be retrieved in the program background, i.e. by specific dedicated threads, and presented one by one in the view pane without involving any complex or repetitive actions by the user. The superfluous operations which the user needs not perform include the prior art steps of returning from the examination of one document to the list of document references (or search hits) from where to select another document to examine and so on, a process which doubles the number of steps to perform. The method helps the user to easily skim through the successive views to retrieve information.

By “single operation”, it should be understood within the context of the invention that, on the one hand, one needs not return to the result list to show the next view or next document and, on the other hand, by way of a single, common, interacting operation a user can pass from one item to another transparently across documents.

When two or more search item occurrences, for instance two or more relevant keywords, appear close together in a given document and when they are shown in a same view, the “showing in the pane of another view of the first document, with the further occurrence being visible” covers at least two different embodiments. The first embodiment consists in showing a new view of the first document “centered” on the next item occurrence, i.e. shifted and slightly different from the first view. This first embodiment makes scrutinizing documents safer.

The second embodiment by contrast consists in passing from a group of occurrences to another group when the occurrences of a group are all visible when the first occurrence of the group is visible. This embodiment enables further search acceleration and streamlining. Further embodiments are also possible, with intermediate ways of operation, e.g. parameterized ways of operation. All these embodiments are covered by the claimed method.

It has been observed that a user interacting with the interface of the method according to the invention has the impression that he is examining one single logically-related set of documents, or in the common case of web searches he may have the impression that he is browsing on one single, consistent web site, which exclusively relates to the initial search character string. The method further provides motion economy in the ergonomic sense of the expression.

Additionally such a method and computer program inherently enables more reliable control of the results presented to the user and in this sense the method constitutes a flexible base platform from easily tuning and controlling the returned results. Indeed, in embodiments of the invention, returned results may be filtered so that to remove redundant documents, out-of-date documents or documents which do not contain the search string may be put aside. In addition, in embodiments of the invention, returned results may be reordered according to their true relevance.

This may be of a particular importance for instance if the user searches the Internet, if the queried search engine uses algorithms such as the PageRank algorithm from Google, which may be subject to spurious manipulation by commercial interests to modify their relevancy ranking, a practice called “spamdexing” or “search engine spamming”, in order to sort the documents according to the true and current content for presenting them to the user.

Practices which may pollute the returned search results include disguising keywords, phrases or links into hidden sections of an HTML page, i.e. hidden only for a user but visible for a web crawler or spider (for instance using tiny font sizes, character with the same colour as the background, keywords in a “no frame section” and other techniques), using page redirects (using META refresh tags, CGI scripts, Javascript and other techniques), and cloaking (sending to a search engine a version of a document or web page which is different that the one users see).

In one embodiment of the method according to the invention, the views of the documents are structurally pruned. Within the context of the invention, it must be understood that “a structurally pruned view of a document” is a filtered view of this document so that superfluous structural elements are removed, i.e. not downloaded at the outset and then not presented or downloaded but not presented. In combination with the main features of the method according to the invention, this enables to quickly present relevant document parts, so that the user may swiftly be presented with relevant data.

The combination of the structurally pruned view capabilities and the skimming by way of a succession of single operations makes the method particularly user-friendly since superfluous operations are removed while simultaneously the time needed to load document-related data is reduced because only structurally pruned document views are shown. Structurally pruning a document may for instance consist in refraining from retrieving some or all scripts and images, thus reducing needed transaction resources such as transmission bandwidth and CPU time, and thus saving time. Saving transmission bandwidth may also save money for the user if the collection of documents is accessed on a pay-per-byte basis.

In one embodiment of the method, the view is a structurally-pruned view selected from the group consisting of a script-free view, an image-free view, a sound-free view, an applet-free view and a combination of any number of the previously mentioned views. This embodiment is advantageous since certain structural elements of documents, which may consume a lot of memory, need not be downloaded because they are not presented in the pane.

If the document collection is the Internet and if documents are HTML documents, the method is advantageous and enables people with limited bandwidth resources to quickly access information without waiting too long for the images to be downloaded for instance. As already mentioned, the method may also reduce the cost of an Internet provider bill, should the cost of the line depend on downloaded volume or time spent online.

It may further increase computer security when surfing on the web for instance since the structurally pruned views may advantageously be free of client-side scripts and other embedded components so that the risk of installing malwares, spywares and other undesirable software programs is greatly reduced.

In a particular embodiment, if a retrieved document contains a plurality of frames, the structurally pruned view of the document may consist in selecting the very frame containing useful information (i.e. the items or keywords) and preventing other frames from being displayed.

In one embodiment of the method, the single operation consists in an operation selected from the group consisting of pressing a particular keyboard key, a particular combination of keyboard keys, pressing a mouse button, emitting a particular sound or word to be recognised by voice-recognition means, touching a screen with a finger and touching the screen with a stylus.

In one embodiment of the method, the user interface includes auxiliary interacting means for the user to interact in a single auxiliary operation through an input device to trigger the showing in the pane of a view of another referenced document, so that the user can rapidly skim through the successive views by a succession of single operation without having to see all items, for instance all keywords of a given document. This is useful to “escape” from a document, if for instance the document is manifestly of no interest or if it appears that the document presents a large amount of items or keywords without manifestly providing more useful relevant information than already obtained.

In one embodiment of the method, items are highlighted in the views to further make identification of relevant information easier.

In one embodiment of the method, the step of retrieving from the search engine a set of at least one document reference includes the removal of duplicate references. This particular embodiment enables a user to skim through the views and get data more quickly since duplicate documents and mirror sites are removed.

In one embodiment of the method, the step of retrieving at least one referenced document includes removing documents which do not include the search character string.

In one embodiment of the method according to the invention, the step of retrieving at least one referenced document includes the removal of documents which are not accessible.

In one embodiment of the method, it further includes a step of constituting a file with the content of the at least one referenced documents. In the context of the invention a file is an agglomerated, optionally indexed set of documents. Once the file is constituted, the user may save the file to examine it later (which may be done off-line to save money if the access to the collection is not free) or he may constitute a library of content files, each of them relating to a particular subject described by a search character string. However, the user needs not wait for the completion of the file before examining it. As soon as the file is at least partially constituted, i.e. shortly after launching the search, the documents of the file may be examined in the view pane.

The invention also relates to a computer program comprising program instructions for causing a computer to perform the method according to the invention. The computer program may run on an end-user computer, i.e. on a client computer of the client-server model.

In one embodiment, the computer program is embodied on a computer-readable storage medium, such as a memory device, a compact disc, a floppy disc, a computer hard disc, RAM, ROM, magnetic tape or any means for storing digital information.

In a further embodiment, the computer program is stored on a record medium.

In a further embodiment, the computer program is embodied in a read-only memory.

In a further embodiment, the computer program is carried on an electrical carrier signal, such as a carrier wave.

The invention further relates to a computer containing the computer program according to the invention.

The invention further relates to a carrier having thereon a computer program according to the invention.

In a further embodiment, the carrier is an electrical carrier, such as a radio frequency (RF) or microwave carrier, a T-carrier or the like.

In a further embodiment, the carrier is an optical carrier, such as an optical carrier, for instance a OC-3, OC-12 or OC-48 line.

The invention further relates to a computer containing a computer program for generating a user interface for use in the method according to the invention.

The invention further relates to a information processing apparatus for presenting data from a collection of documents, including means for retrieving a search character string; means for identifying at least one item within the string; means for making a query depending on the string to at least one search engine capable of returning a set of references to documents from the collection; means for retrieving from the engine a set of at least one document reference; and means for retrieving at least one document referenced in the retrieved set; means for generating a signal capable of graphically presenting in a display a user interface including a pane showing a view of a first one of the at least one referenced document, a first occurrence of the at least one item being visible; and including interacting means for a user to interact in a single operation through an input device to trigger if the first document contains a further occurrence of the at least one item, the showing in the pane of another view of the first document, with the further occurrence being visible; and otherwise, the showing in the pane of a view of another one of the at least one referenced document, an occurrence of the at least one item being visible.

### SHORT DESCRIPTION OF THE DRAWINGS

These and further aspects of the invention will be explained in greater detail by way of example and with reference to the accompanying drawings in which:

FIG. 1 shows a schematic view of an embodiment of the method according to the invention;

FIG. 2 shows a schematic view of a basic user interface generated on a display by an embodiment of the method or the computer program according to the invention; and

FIG. 3 shows a schematic view of another user interface generated on a display by another embodiment of the method or the computer program according to the invention.

The figures are not drawn to scale. Generally, identical components are denoted by the same reference numerals in the figures.

### DETAILED DESCRIPTION OF PREFERRED EMBODIMENTS

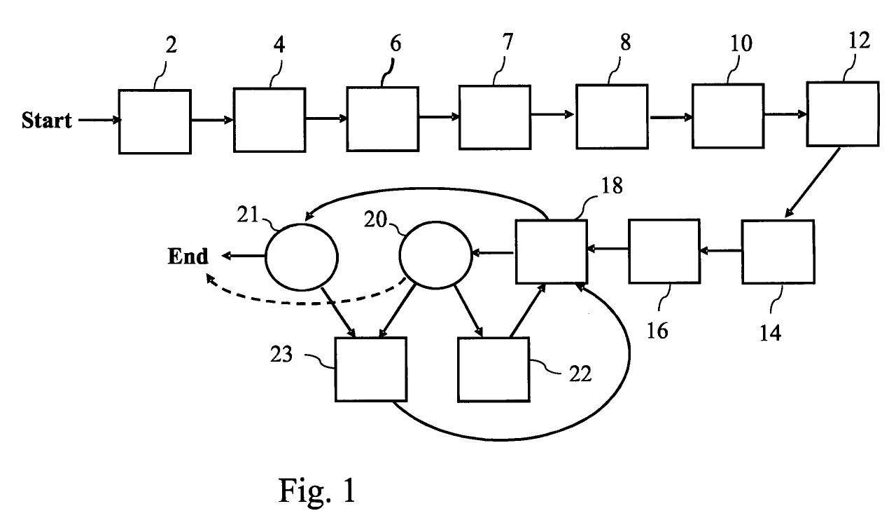

FIG. 1 shows a schematic view of an embodiment of the method according to the invention, in the form of a flow chart, wherein the method starts, i.e. when the computer program is launched, i.e. when the computer program instructions are locally executed on the computer process unit (CPU) of a client-side computer.

The first step or at least one of the first steps after the program is launched, since it will be clear for the person skilled in the art that there may be initialization steps beforehand, is the generation 2 of a user interface 28, i.e. the generation of a signal or instructions representing a user interface 28 on a video display terminal, a monitor, a computer screen or the like.

The user interface 28, for instance a command-line interface (CLI) or a graphical user interface (GUI), prompts 4 the user to introduce a search character string. In a graphical user interface 28, this step of prompting 4 may take the form of presenting a text field 26 or a text control for entering the search string through input characters from a keyboard or the like.

Once the search string has been introduced in the text field 26 or in the command line and once for instance the “carriage return” key has been pressed, the program then retrieves 6 the search string, identifies 7 items within the string (this step may be done later though), and sends 8 a corresponding query to a search engine, for instance to a remote web search engine, such as Google, MSN Search, AltaVista, Yahoo!, The Northern Light or AlltheWeb. In other words, the program automatically makes 8 a formatted query to a search engine.

In one embodiment, the remote web search engine is selected by the user from a plurality of remote web search engines before introducing the search string.

Coming back to the embodiment illustrated in FIG. 1, after the query has been sent 8 to the at least one search engine, the results, i.e. the document references or search hits, are then retrieved 10 from the search engine. In the web search example, a document reference may be for instance be a Uniform Resource Locator (URL) or web address, as defined in Internet Engineering Task Force (IETF) standard RFC 2396.

Some search engines also returns short description along with references. In one embodiment, short descriptions are fetched by the program along with document references.

In one embodiment, at this stage, the document references are filtered. For instance, references are filtered to remove any duplicate references, to remove references for which the short description is identical to the short description already obtained for a previous reference (this indicates that the second page is likely to be a mirror of the first one), to remove references that do not match criterions such as the type of file, the web domain (in the web search example), or the like.

Coming back to the embodiment illustrated in FIG. 1, the referenced documents are then retrieved 12, stored on the client-side computer memory, and the document content is indexed 14. Then, as soon as one document has been retrieved 12, a structurally pruned view of the document is shown 16 on the view pane 24 of the user interface 28. The view shows inter alia the first keyword found in the document. This means for instance that the view is centered on the first keyword.

At this stage, the user interface 28 generated by the program presents a capability to respond to a single input operation from a user, i.e. a particular stimulus on an input device, such as a keyboard, a mouse, a trackball, a touch screen or a microphone.

In other words, the user interface 28 waits 18 an input interaction from a user, i.e. it listens to events, and, once a particular, dedicated, single operation or event is detected, the program checks 20 whether there is still one keyword in the current document. If so, a new view of the current document is shown 22 but this time centered on the newly detected keyword, i.e. the next keyword. Otherwise, a structurally pruned view of another document is shown 23, centered on the first keyword found within the other document. If there is no more document in the set, the program ends (see dashed line leading to the “End” element in the flowchart) or returns to an idle state, not illustrated in FIG. 1.

In this embodiment, at the waiting stage 18, the user interface 28 further presents a capability to respond to an auxiliary single input operation. Once detected, the program checks 21 whether there is still one document in the set of documents. If it is the case, a structurally pruned view of another one of the referenced documents is shown 23 in the view pane 24, and the computer program in the waiting state 18. Otherwise, the program ends or returns to an idle state.

As soon as one document has been retrieved 12 or more precisely as soon as the meaningful text-only elements of the document have been retrieved, the user can skim through the document. The user needs not to wait until the end of the complete download of all documents before starting to access the information from the retrieved documents. The user can rapidly start examining fetched documents.

The method according to the invention directly displays a view of a first result and lets the user examine the successive views of the relevant documents. So the method of the invention goes against the paradigm wherein the user selects a particular hit from a list. While this prior art “choose and select paradigm” represents an undeniable freedom feature for users, it has been observed that going against this paradigm offers striking and surprising advantages in that the time needed for a search and the frustration experienced during a search are greatly reduced. Furthermore the passage from one item or keyword to another one, both inside a document and across documents and in a transparent manner, is undeniably advantageous to efficiently examine a collection of documents referenced by one or a plurality of search engines.

In a further embodiment, the method includes a step of following references or links mentioned in a retrieved referenced document and retrieving the “sub-documents” to where each reference leads. The method may include following several levels or “depths” of links.

In a further embodiment, the method includes collecting images or videos in a particular file or in a particular part of a file constituting by all retrieved documents.

In a further embodiment, the method includes the capability to refine the search in a rapid and purely off-line manner, thus enabling off-line browsing and searching.

It has been observed that a web search taking an average 11 minutes with a conventional web search engine such as Google, only takes 2 minutes with a method according to the invention.

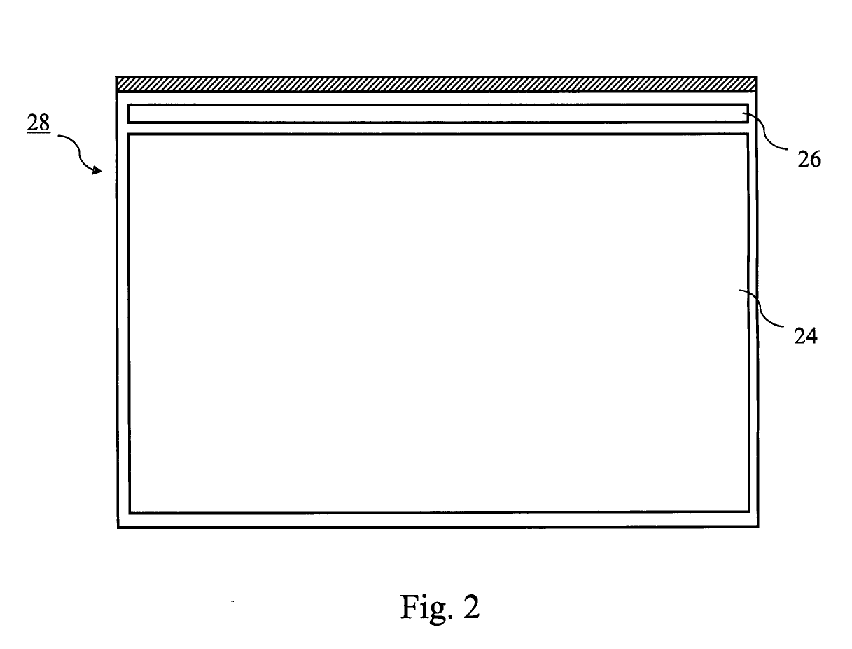

FIG. 2 shows a schematic view a basic user interface 28 generated on a display by an embodiment of the method according to the invention. It includes a window comprising a text control or text field 26 for entering the search character string, i.e. the keywords, phrases or expressions, and a view pane 24 for showing 16, 22, 23 the structurally pruned view of a fetched document. Small buttons for closing, maximizing or minimizing the window are not included for the sake of conciseness of the figure, but it will be clear for the person skilled in the art that they may be included.

In this user interface 28, the single operation may for instance consist in pressing the “carriage return” key on a keyboard, thus prompting the passage to the next keyword, while the single auxiliary operation may consist in pressing the “arrow down” keyboard key, thus prompting the passage to the next document.

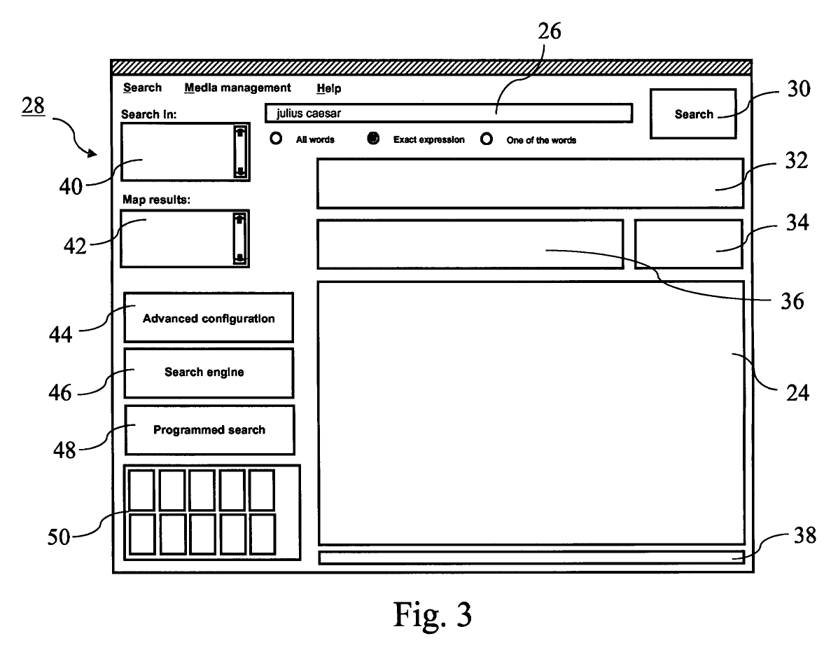

FIG. 3 shows a schematic view of another user interface 28 generated on a display by another embodiment of the method or computer program of the invention.

The text control or text field 26 is shown with an exemplary search string “julius caesar”. The program may support boolean search character strings or natural language requests. The capabilities of the text control, i.e. what it accepts, may match the capabilities of the target search engine. Right below the text field 26, check boxes or radio buttons are included to indicate how the program must comprehend the search string. The check boxes may have the following labels: “all words”, “exact expression” or “one of the words”. The text field 26 may give access to previously introduced search strings through a pull-down menu.

A search button 30 is displayed on the right hand side of the text field 26 to launch a search and start constituting the file. In other words, the search button 30 is the location on the display screen where the user has to click with his pointing device such as a mouse to launch the search. Pressing the “carriage return” key from the keyboard may produce the same result.

Two scrollable lists are displayed on the left side of the user interface 28. The first scrollable list, the “search in” list 40, enables the user to choose in which categories the search should take place. For instance, the options may be “web pages” (in order to retrieve from web pages documents), “web pages (cache)” (in order to retrieve any web pages cached by the remote search engine), “news”, “discussion forums” and so on.

The second scrollable list, the “map results” list 42, enables the user to choose which kind of media should be downloaded for constituting specific additional files of media. This is a useful option in order to download and classify media components about a subject. The list 42 enables to user to select from a series of medium type which one should form an additional file. The list may include the following options: “no media”, “images”, “video”, “music”, “e-books”, “software”, “email”, or combination of these elements. The user interface 28 may include an additional text field (not represented) for enabling introduction of user-specific types of file. This may be done by introducing the file extension(s).

The pane 32 contains a list of all previously constituted files. A context menu may appear when right clicking on the pane 32 and may include such options as “deleting a constituted file”.

The pane 36 shows the index organization of the already constituted file or alternatively the file being constituted. A context menu may appear when right clicking on the pane 36 and may include such options as “browsing the web link”, “browsing the web link containing this medium”, “copy the web link”, and the like.

The pane 34 contains an indication on whether the document shown on the view pane 24 contains media, which are not be displayed. A context menu of this pane 34 allows users to browse the web site from where the document comes.

The view pane 24 shows 16, 22, 23 structurally pruned views of documents, i.e. for instance without images, client-side scripts (ignoring anything found within a SCRIPT element when loading a HTML document, ignoring HTML events such as on Load, onUnload, on Focus, on Blur, on MouseOver, on Resize and the like, and so on), and applets (such as Java applets and Macromedia Flash). Again, a context menu may allow the user to locally edit the page, to bookmark it, to copy and paste it or to browse the web site from where the document comes.

An advanced configuration button 44, a search engine button 46 and a programmed search button 48 may lead to special menus intended respectively to configure the program, to select search engines and to preprogram a search and constitute a file.

Finally, status bar 38 and elements 50 may provide information regarding the state of the program.

In one embodiment of the method and the computer program, the number of search results to be taken into account by search engine may be defined by the user. The user may further select the countries in which the web search should take place.

From an implementation point of view, the person skilled in the art will understand that many programming languages and many types of implementations may be undertaken.

In one embodiment, the program involves a <<Browser>> class and a <<Scan>> class in an object-oriented programming language, each object of the class having the capability to include properties and handle events. The <<Browser>> class has the function of generating a hypertext document browser and loading interpretation layers associated with the format of the document to display. The <<Scan>> class has the function of downloading a document and extracting its links. This class has a further function of normalizing and handling the links.

The <<Scan>> class may optionally include a capability to recursively analyze several depths of documents. For instance, according to this option, an object of the <<Scan>> class retrieves a document and n links in this document, stores the links in a buffer, creates n threads on the links stored in the buffer, retrieves 10 the links in these n documents, stores again these newly found links in the buffer and so on.

In one program cycle, 1 to N1 threads are launched when the search starts. The number of launched threads is determined by the number of documents the user wishes to retrieve (user-defined as a parameter) and by the maximum number of documents the search engine can retrieve 12 at a time (defined by the search engine). For instance, if a search engine, such as Google, can retrieve 10 one hundred links at a time and if the user wishes two hundred links and documents, two threads will be launched in order to retrieve 10 the set of references. In a multiple search engine embodiment, the principle is identical although the number of threads is determined per search engine.

The step of filtering references, such as removing duplicate references or removing references contravening some user-defined criterions, takes place then (i.e. when retrieving 10 and storing the links) on the basis of a table or of a temporary database for instance.

As soon as the documents containing the list of references have been entirely parsed so as to retrieve 10 the links, a list of references to documents is then available along with optional document descriptions, titles or extracts depending on what the search engine offers. The program may be parameterized so that URL redirections are not followed.

1 to N2 <<Scan>> objects are then created (with a corresponding number of threads since the class <<Scan>> implements <<Thread>>) for retrieving 12, e.g. downloading, and parsing the documents from the available list of references to documents. The documents are parsed and interpreted in an object of the <<Scan>> class.

A further step of filtering then takes place to check whether the documents are consistent with the search string. Documents are displayed only when it is ascertained that they contain at least one item or keyword included in the search string.

The first document meeting the criterions is then displayed by way of a <<Browser>> object. The interaction process can then start, while threads are working in background.

When the documents are interpreted, their portions are stored in object fields (in an object-oriented implementation) or in a particular element of the database (in a database implementation). Off-line filtering or refining may then be easily performed, for instance by a “SELECT”.

In one embodiment, images, sound files and the like are downloaded and include in a dedicated compressed archive or in their original form.

In one embodiment, during the process of passing from one view to another, the group of items on which focus is successively directed, or in other words the group of items whose successive occurrences are visible in the pane 24, can be altered by the user so as to add items not part of the search string and focus on more items than found in the search string. Items part of the search string can also be removed from the group of items taken into account to select the views, so as to focus on less items than found in the search string. This provides more flexibility and control to users.

For example, if the search string contains “Julius OR Caesar”, the retrieved documents are retrieved 12 on the basis of this string but the user can later alter the keywords used to select the successive views. The user may suddenly wish to see views containing to “Julius OR Caesar OR Cleopatra” (he will then see more views) or “Julius” or the exact phrase “Julius Caesar” (he will then generally see less views) or “Julius OR Cleopatra” or even “Cleopatra”.

In the above-described embodiment, the user interface 28 further includes auxiliary interacting means for the user to interact through an input device to alter the at least one item, so that as soon as the auxiliary interacting means are operated the remainder of the method is based on the altered at least one item (until the means are again operated for instance). As described above, altering may mean adding one or more items to the group of items, removing one of the items from the group of items, substituting one or more items for one or more other items in the group of items, or a combination of two or three of these operations, provided that there is always at least one item in the group of items.

It will be clear for the person skilled in the art that the computer may be a personal computer (PC), a desktop computer, a server, a laptop, a notebook, a mobile phone, a personal digital assistant (PDA), a personal organizer, a handheld device, or any type of devices including at least one processor unit (CPU) and a memory, or in other words at least processing means and memory means. The person skilled in the art will also recognised that the so-called computer may include a bus, a network interface, input and output devices and other various components.

It will be further clear for the person skilled in the art that the computer program may be software running on a computer, a hard wire or hardware embedded program, a firmware. The computer program may be integrated in a web browser, for instance in the form of a toolbar, or in the form of an applet embedded in a web search engine page.

It will be further clear for the person skilled in the art that the document is a generic term for any type of document such a HTML page, a Microsoft word document, a PDF document, and the like. The expression “collection of documents” covers any type of collections of documents, such as for instance the web, the Internet, an intranet, a network, or the like.

It will be further clear for the person skilled in the art that the search character string includes at least one item of a given type, separated by a space character or any kind of separator. The items may for instance be words, phone numbers, postal codes, ideograms (such as kanjis or Hanja), graphic symbols, logograms, pictograms, morphemes, lexemes, codons in DNA codes, and more generally any type of semantic unit or the like, or a combination of them.

It will be further clear for the person skilled in the art that transmitting 8 the query to the at least one search engines and retrieving 10, 12 the data may be done through any type of conveying means or transmission protocols, for instance through HyperText Transfer Protocol (HTTP) (client) requests and (server) responses over TCP/IP.

It will be appreciated by persons skilled in the art that the present invention is not limited by what has been particularly shown and described hereinabove. The invention resides in each and every novel characteristic feature and each and every combination of characteristic features. Reference numerals in the claims do not limit their protective scope.

1. Method performed by a computer program within a computer for presenting data from a collection of documents, including the steps of
retrieving a search character string;
identifying at least one item within the string;
making a query depending on the string to at least one search engine capable of returning a set of references to documents from the collection;
retrieving from the engine a set of at least one document reference; and
retrieving at least one document referenced in the retrieved set;
generating a signal capable of graphically presenting in a display a user interface
including a pane showing a view of a first one of the at least one referenced document, a first occurrence of the at least one item being visible; and
including interacting means for a user to interact in a single operation through an input device to trigger
if the first document contains a further occurrence of the at least one item, the showing in the pane of another view of the first document, with the further occurrence being visible; and
otherwise, the showing in the pane of a view of another one of the at least one referenced document, an occurrence of the at least one item being visible.

2. Method according to claim 1, wherein the view is a structurally pruned view.

3. Method according to claim 2, wherein the structurally pruned view is a view selected from the group consisting of a script-free view, an image-free view, a sound-free view, an applet-free view and a combination of any number of the previously mentioned views.

4. Method according to claim 1, wherein the user interface further includes auxiliary interacting means for the user to interact in a single auxiliary operation through an input device to trigger the showing in the pane of a view of another one of the at least one referenced document, no matter whether all the occurrences of the items of the first document have been previously viewed or not.

5. Method according to claim 1, further including, after retrieving at least one document referenced in the retrieved set, a step of indexing the content of the at least one referenced document.

6. Method according to claim 1, wherein the single operation is an operation selected from the group consisting of pressing a particular key of a keyboard, a particular combination of keys of a keyboard, pressing a button of a mouse, emitting a particular sound or word to be recognised by voice-recognition means, touching a screen with a finger and touching the screen with a stylus.

7. Method according to claim 1, wherein the step of retrieving from the engine a set of at least one document reference includes the removal of duplicate references.

8. Method according to claim 1, wherein the step of retrieving at least one document referenced in the retrieved set includes the removal of documents that do not include the string.

9. Method according to claim 1, wherein the step of retrieving at least one document referenced in the retrieved set includes the removal of inaccessible documents.

10. Method according to claim 1, further including a step of constituting a file with the content of the at least one referenced documents.

11. Computer program comprising program instructions for causing a computer to perform the method of claim 1.

12. Computer program according to claim 11, embodied on a computer-readable storage medium.

13. Computer program according to claim 11, stored on a record medium.

14. Computer program according to claim 11, embodied in a read-only memory.

15. Computer program according to claim 11, carried on an electrical carrier signal.

16. Computer containing the computer program according to claim 11.

17. Carrier having thereon a computer program according to claim 11.

18. Carrier according to claim 17, wherein the carrier is an electrical carrier.

19. Carrier according to claim 17, wherein the carrier is an optical carrier.

20. Computer containing a computer program for generating a user interface according to claim 1.

21. Information processing apparatus for presenting data from a collection of documents, including
means for retrieving a search character string;
means for identifying at least one item within the string;
means for making a query depending on the string to at least one search engine capable of returning a set of references to documents from the collection;
means for retrieving from the engine a set of at least one document reference; and
means for retrieving at least one document referenced in the retrieved set;
means for generating a signal capable of graphically presenting in a display a user interface
including a pane showing a view of a first one of the at least one referenced document, a first occurrence of the at least one item being visible; and
including interacting means for a user to interact in a single operation through an input device to trigger
if the first document contains a further occurrence of the at least one item, the showing in the pane of another view of the first document, with the further occurrence being visible; and
otherwise, the showing in the pane of a view of another one of the at least one referenced document, an occurrence of the at least one item being visible.

22. Apparatus according to claim 21, wherein the view is a structurally pruned view.

23. Apparatus according to claim 22, wherein the structurally pruned view is a view selected from the group consisting of a script-free view, an image-free view, a sound-free view, an applet-free view and a combination of any number of the previously mentioned views.

24. Apparatus according to claim 21, wherein the user interface further includes auxiliary interacting means for the user to interact in a single auxiliary operation through an input device to trigger the showing in the pane of a view of another one of the at least one referenced document, no matter whether all the occurrences of the items of the first document have been previously viewed or not.

25. Apparatus according to claim 21, further including means for indexing the content of the at least one referenced document.

26. Apparatus according to claim 21, wherein the single operation is an operation selected from the group consisting of pressing a particular key of a keyboard, a particular combination of keys of a keyboard, pressing a button of a mouse, emitting a particular sound or word to be recognised by voice-recognition means, touching a screen with a finger and touching the screen with a stylus.

27. Apparatus according to claim 21, wherein the means for retrieving from the engine a set of at least one document reference includes means for removing duplicate references.

28. Apparatus according to claim 21, wherein the means for retrieving at least one document referenced in the retrieved set includes means for removing documents that do not include the string.
